(19) United States
(12) Patent Application Publication
(10) Pub. No.: US 2020/0322557 A1
(43) Pub. Date: Oct. 8, 2020

(54) IMAGE SENSOR AND METHOD OF DRIVING THE SAME

(71) Applicant: SAMSUNG ELECTRONICS CO., LTD., Suwon-si (KR)

(72) Inventor: Eun Sub Shim, Hwaseong-si (KR)

(21) Appl. No.: 16/568,972

(22) Filed: Sep. 12, 2019

(30) Foreign Application Priority Data
Apr. 8, 2019 (KR) 10-2019-0040877

(51) Int. Cl. H04N 5/378; H04N 5/376

(52) U.S. Cl. CPC H04N 5/378; H04N 5/3765

(57) ABSTRACT

An image sensor includes a correlated double sampling (CDS) circuit. The CDS circuit includes a comparator having a first input terminal connected to a first node, a second input terminal, and an output terminal connected to a second node, a multi-sampling pulse generator having an input terminal and at least one output terminal, and a multi-sampling circuit. The multi-sampling circuit includes a correction capacitor disposed between an input terminal of the CDS circuit and the first node, and at least one sampling capacitor disposed between the at least one output terminal of the multi-sampling pulse generator and the first node.

### CROSS-REFERENCE TO RELATED APPLICATIONS

This application claims priority under 35 U.S.C. § 119 to Korean Patent Application No. 10-2019-0040877, filed on Apr. 8, 2019, the disclosure of which is incorporated by reference herein in its entirety.

### TECHNICAL FIELD

Exemplary embodiments of the present inventive concept relate to an image sensor, and more particularly, an image sensor capable of reducing a sampling time, and a method of driving the same.

### DISCUSSION OF THE RELATED ART

An image sensor may include correlated double sampling (CDS) circuits, each arranged with a corresponding one of columns of a pixel array. The CDS circuits may perform CDS on signals output from the columns. The image sensor may compare a difference between a reset signal and an image signal which are sampled by CDS, and output a comparison result in the form of a digital signal. Single sampling or multi-sampling may be performed on the signals output from each column using the CDS circuits. When multi-sampling is performed on the signals, a sampling time may increase in proportion to the number of times of sampling.

### SUMMARY

Exemplary embodiments of the inventive concept are directed to providing an image sensor capable of preventing a sampling time from increasing when multi-sampling is performed using dual correlated double sampling (CDS), and a method of driving the same.

According to an exemplary embodiment, an image sensor includes a correlated double sampling (CDS) circuit. The CDS circuit includes a comparator having a first input terminal connected to a first node, a second input terminal, and an output terminal connected to a second node, a multi-sampling pulse generator having an input terminal and at least one output terminal, and a multi-sampling circuit. The multi-sampling circuit includes a correction capacitor disposed between an input terminal of the CDS circuit and the first node, and at least one sampling capacitor disposed between the at least one output terminal of the multi-sampling pulse generator and the first node.

According to an exemplary embodiment, an image sensor includes a correlated double sampling (CDS) circuit. The CDS circuit includes a comparator having a first input terminal to which a pixel signal is input, a second input terminal to which a ramp signal is input, and an output terminal. The first input terminal is connected to a first node, and the output terminal is connected to a second node. The CDS circuit further includes a multi-sampling pulse generator including an input terminal connected to the output terminal of the comparator, and at least one output terminal connected to the first input terminal of the comparator. The CDS circuit further includes a multi-sampling circuit. The multi-sampling circuit includes a correction capacitor disposed between an input terminal of the CDS circuit and the first input terminal of the comparator, and at least one sampling capacitor disposed between the multi-sampling pulse generator and the first input terminal of the comparator.

According to an exemplary embodiment, a method of driving an image sensor including a correlated double sampling (CDS) circuit includes gradually changing a voltage value of a reset signal input to a first input terminal of the CDS circuit in a reset sampling period, and applying a first ramp signal having a constant slope to a second input terminal of the CDS circuit. The method further includes comparing the first ramp signal with the reset signal having the voltage value which is gradually changed, and outputting a corresponding comparison result. The method further includes sequentially changing a voltage value of an image signal input to the first input terminal of the CDS circuit, and applying a second ramp signal having a constant slope to the second input terminal of the CDS circuit in a signal sampling period. The method further includes comparing the second ramp signal with the image signal having the voltage value which is gradually changed, and outputting a corresponding comparison result.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a schematic block diagram of an image processing device including an image sensor according to an exemplary embodiment of the inventive concept.

FIG. 2 is a view showing a portion of the image sensor of FIG. 1 according to an exemplary embodiment of the inventive concept.

FIG. 3 is a view showing one unit pixel of a pixel array of FIG. 2 according to an exemplary embodiment of the inventive concept.

FIG. 4 is a view showing a correlated double sampling (CDS) block of a read-out circuit of FIG. 1 according to an exemplary embodiment of the inventive concept.

FIG. 5A is a view showing a CDS circuit of the CDS block of FIG. 4 according to an exemplary embodiment of the inventive concept.

FIG. 5B is a view showing a CDS circuit of the CDS block of FIG. 4 according to an exemplary embodiment of the inventive concept.

FIG. 5C is a view showing a CDS circuit of the CDS block of FIG. 4 according to an exemplary embodiment of the inventive concept.

FIG. 6 is a view showing an analog-to-digital converter (ADC) of a read-out circuit of FIG. 2 according to an exemplary embodiment of the inventive concept.

FIG. 7A is a timing diagram of signals for driving the image sensor of FIG. 1 according to an exemplary embodiment of the inventive concept.

FIG. 7B is a timing diagram of signals for driving the image sensor of FIG. 1 according to an exemplary embodiment of the inventive concept.

FIG. 7C is a timing diagram of signals for driving the image sensor of FIG. 1 according to an exemplary embodiment of the inventive concept.

FIG. 8 is a timing diagram of signals for driving the image sensor of FIG. 1 according to an exemplary embodiment of the inventive concept.

FIG. 9 is a view showing a CDS circuit of the CDS block of FIG. 4 according to an exemplary embodiment of the inventive concept.

FIG. 10 is a timing diagram of signals for driving the image sensor of FIG. 1 according to an exemplary embodiment of the inventive concept.

FIG. 11 is a view showing a CDS circuit of the CDS block of FIG. 4 according to an exemplary embodiment of the inventive concept.

### DETAILED DESCRIPTION

Exemplary embodiments of the present inventive concept will be described more fully hereinafter with reference to the accompanying drawings. Like reference numerals may refer to like elements throughout the accompanying drawings.

The terms “first,” “second,” “third,” etc. are used herein to distinguish one element from another, and the elements are not limited by these terms. Thus, a “first” element in an exemplary embodiment may be described as a “second” element in another exemplary embodiment.

Descriptions of features or aspects within each exemplary embodiment should typically be considered as available for other similar features or aspects in other exemplary embodiments, unless the context clearly indicates otherwise.

As used herein, the singular forms “a”, “an” and “the” are intended to include the plural forms as well, unless the context clearly indicates otherwise.

Hereinafter, image sensors and methods of driving the same according to exemplary embodiments of the inventive concept will be described with reference to the accompanying drawings.

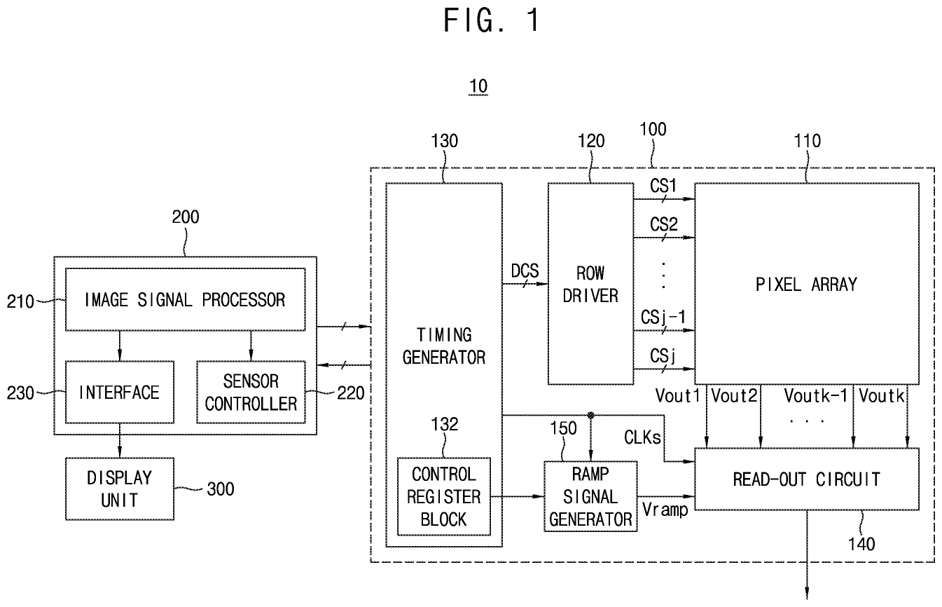

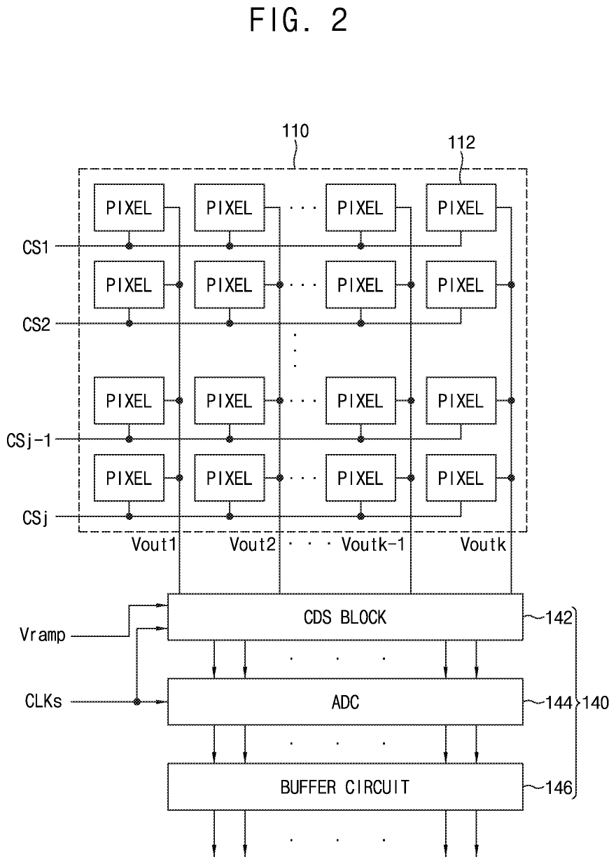

FIG. 1 is a schematic block diagram of an image processing device 10 including an image sensor 100 according to an exemplary embodiment of the inventive concept. FIG. 2 is a view showing a portion of the image sensor 100 of FIG. 1 according to an exemplary embodiment of the inventive concept.

Referring to FIGS. 1 and 2, the image processing device 10 may include the image sensor 100 and a digital signal processor (DSP) 200. The image sensor 100 may sense an object captured through a lens under the control of the DSP 200. The DSP 200 may transmit an image, which is sensed by the image sensor 100 and output, to a display unit 300.

The DSP 200 may include an image signal processor 210, an image sensor controller 220, and an interface 230. The image signal processor 210 may control the image sensor controller 220 and the interface 230.

The image sensor 100 may include a pixel array 110, a timing generator 130, a read-out circuit 140, and a ramp signal generator 150.

The read-out circuit 140 may include a correlated double sampling (CDS) block 142, an analog-to-digital converter (ADC) 144, and a buffer circuit 146.

The timing generator 130 may include a control register block 132. The control register block 132 may control the timing generator 130, the read-out circuit 140, and the ramp signal generator 150 according to the control of the DSP 200. The timing generator 130 may generate switch control signals for turning switches disposed in the CDS block 142 of the read-out circuit 140 on/off, and transmit the generated switch control signals to the CDS block 142. The timing generator 130 may generate row driver control signals DCS. The row driver control signals DCS generated by the timing generator 130 may be input to a row driver 120. Control signal clocks CLKs may be input to the read-out circuit 140 from the timing generator 130.

The row driver 120 may generate a plurality of row control signals CS1 to CSj (j is a positive integer) on the basis of the plurality of row driver control signals DCS received from the timing generator 130. The row driver 120 may transmit the plurality of row control signals CS1 to CSj to the pixel array 110. Since each of the plurality of row control signals CS1 to CSj corresponds to one of j rows of the pixel array 110, the pixel array 110 may be controlled for each row. The plurality of row control signals CS1 to CSj may include, for example, an overflow control signal, a storage control signal, a transmission control signal, a reset control signal, and a selection control signal. The pixel array 110 may transmit pixel signals Voutl to Voutk (k is a positive integer) to the read-out circuit 140 in response to the row control signals CS1 to CSj input from the row driver 120. The pixel signals Voutl to Voutk may include, for example, a reset signal reset and an image signal Vpix.

The ramp signal generator 150 may generate a plurality of ramp signals Vramp on the basis of the control signals generated by the timing generator 130. The ramp signal generator 150 may output a ramp signal Vramp having a constant falling or rising slope. The ramp signal generator 150 may supply the ramp signal Vramp to the CDS block 142 of the read-out circuit 140. For example, the ramp signal generator 150 may generate a first ramp signal Vramp1 for sampling of the reset signal reset, and may supply the generated first ramp signal Vramp1 to the CDS block 142 in a reset sampling period. The ramp signal generator 150 may generate a second ramp signal Vramp2 for sampling of the image signal Vpix, and may supply the generated second ramp signal Vramp2 to the CDS block 142 in a signal sampling period.

Although the image signal processor 210 is shown in FIG. 1 as being disposed inside the DSP 200, the location of the image signal processor 210 is not limited thereto. For example, in an exemplary embodiment, the image sensor 100 and the DSP 200 may each be implemented as a separate chip and may be integrated into a multi-chip package. For example, the image sensor 100 and the image signal processor 210 in the DSP 200 may be integrated into one chip.

The image signal processor 210 may process digital pixel signals received from the image sensor 100, generate image data, and transmit the image data to the interface 230.

The image sensor controller 220 may generate a plurality of control signals for controlling the row driver 120, the timing generator 130, the control register block 132, the read-out circuit 140, and the ramp signal generator 150, and may transmit each of the plurality of control signals. In an exemplary embodiment, the image sensor controller 220 may control the row driver 120, the timing generator 130, the control register block 132, the read-out circuit 140, and the ramp signal generator 150 using an Inter-Integrated Circuit (I²C) communication method.

The interface 230 may output the image data processed by the image signal processor 210 to the outside (e.g., to a device external to the image processing device 10). For example, the interface 230 may output the image data processed by the image signal processor 210 to the display unit 300. The display unit 300 may include any device capable of outputting an image.

The display unit 300 may include a computer, a portable phone, an image output terminal, etc. Further, the display unit 300 may include, for example, a thin-film-transistor liquid-crystal display (TFT-LCD), a light-emitting diode (LED) display, an organic LED (OLED) display, or an active-matrix OLED (AMOLED) display.

The image processing device 10 may include a portable electronic device. The portable electronic device may include, for example, a laptop computer, a mobile phone, a smartphone, a tablet personal computer (PC), a personal digital assistant (PDA), an enterprise digital assistant (EDA), a digital still camera, a digital video camera, a portable multimedia player (PMP), a mobile Internet device (MID), a wearable computer, an Internet of Things (IoT) device, an Internet of Everything (IoE) device, etc.

As shown in FIG. 2, the pixel array 110 may include a plurality of unit pixels 112 arranged in a matrix form. For example, the pixel array 110 may include the plurality of unit pixels 112, which are arranged in a matrix form, each of which being connected to a plurality of row lines and a plurality of column lines. Each of the plurality of unit pixels 112 may generate a digital pixel signal for a subject which is captured through an optical lens.

The unit pixel 112 may include, for example, a red filter through which light in a red wavelength region passes, a green filter through which light in a green wavelength region passes, and a blue filter through which light in a blue wavelength region passes. However, the inventive concept is not limited thereto. For example, in an exemplary embodiment, the unit pixel 112 may include a color filter or a transparent filter through which light in a wavelength region of another color passes. For example, the unit pixel 112 may include a white filter, a cyan filter, a magenta filter, and/or a yellow filter.

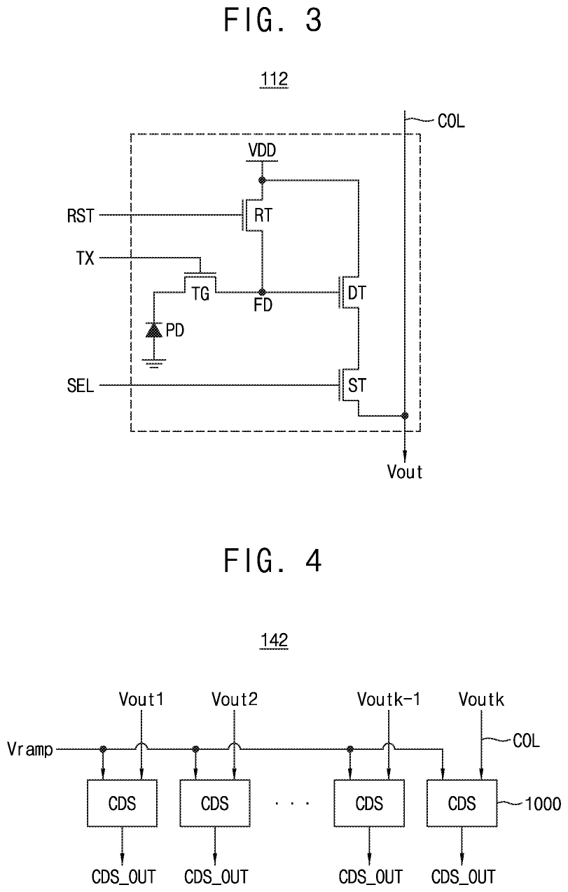

FIG. 3 is a view showing one unit pixel 112 of the pixel array 110 of FIG. 2 according to an exemplary embodiment of the inventive concept.

Referring to FIG. 3, one unit pixel 112 may include a transmission transistor TG, a floating diffusion node FD, a reset transistor RT, a drive transistor DT, a selection transistor ST, and a photodiode PD. Each of the unit pixels 112 may include the configuration shown in FIG. 3. Each of the unit pixels 112 may sense light using the photodiode PD, convert the sensed light into an electrical signal, and generate an image signal.

The transmission transistor TG may transmit a photoelectric conversion signal received from the photodiode PD to the floating diffusion node FD on the basis of a transmission control signal TX which is input to a gate thereof. The photoelectric conversion signal, which is transmitted through the transmission transistor TG, or a reset control signal RST, may be stored in the floating diffusion node FD due to parasitic capacitance caused by a floating junction.

The reset transistor RT may be disposed between a VDD terminal to which a power voltage VDD is input and the floating diffusion node FD. The reset control signal RST may be input to a gate of the reset transistor RT from the row driver 120. The reset transistor RT may control photocharges of the floating diffusion node FD in response to the reset control signal RST. When the reset transistor RT is turned on, the floating diffusion node FD may be reset to be a level of the power voltage VDD.

The drive transistor DT is formed to have a source follower structure, a gate of the drive transistor DT is connected to the floating diffusion node FD, and a source of the drive transistor DT is connected to the VDD terminal. The drive transistor DT may provide a power voltage VDD to the selection transistor ST according to a magnitude of a voltage of the floating diffusion node FD.

The selection transistor ST may be turned on in response to a selection signal SEL. When the selection transistor ST is turned on, the selection transistor ST may output a voltage, which is provided from the drive transistor DT, as a pixel signal Vout. The pixel signal Vout output from each of the unit pixels 112 may be transmitted to the CDS block 142 of the read-out circuit 140.

FIG. 4 is a view showing the CDS block 142 of the read-out circuit 140 of FIG. 1 according to an exemplary embodiment of the inventive concept.

Referring to FIG. 4, the pixel signal Vout output from the unit pixel 112 may have a deviation caused by an intrinsic characteristic difference between pixels, such as, for example, fixed pattern noise (FPN), reset noise, etc. Here, the pixel signal Vout may include the reset signal reset which is output in the reset sampling period and the image signal Vpix which is output in the signal sampling period. Reducing the FPN and the reset noise may improve performance of the image sensor 100. Accordingly, CDS may be performed through the CDS block 142, which may reduce the FPN and the reset noise.

The CDS block 142 may include a plurality of CDS circuits 1000 outputting output signals CDS_OUT. Each of the plurality of CDS circuits 1000 may be connected to each of a plurality of column lines COL arranged in the pixel array 110.

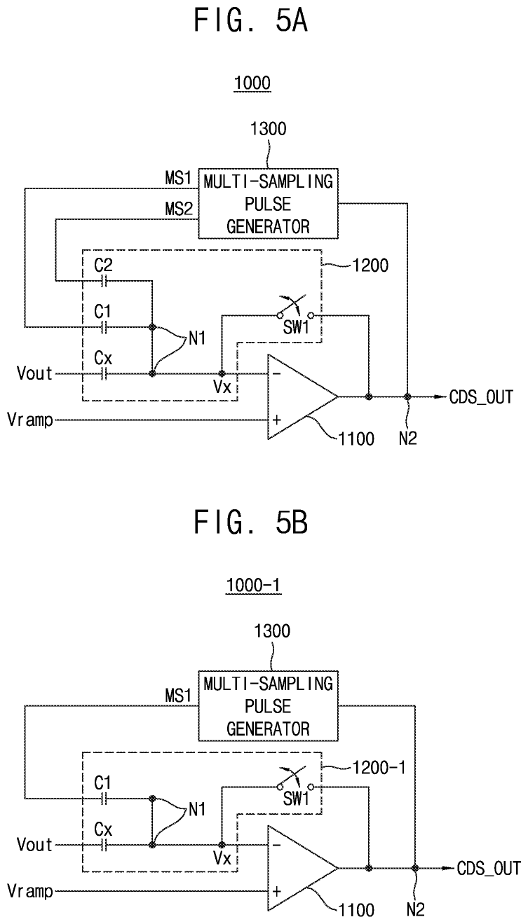

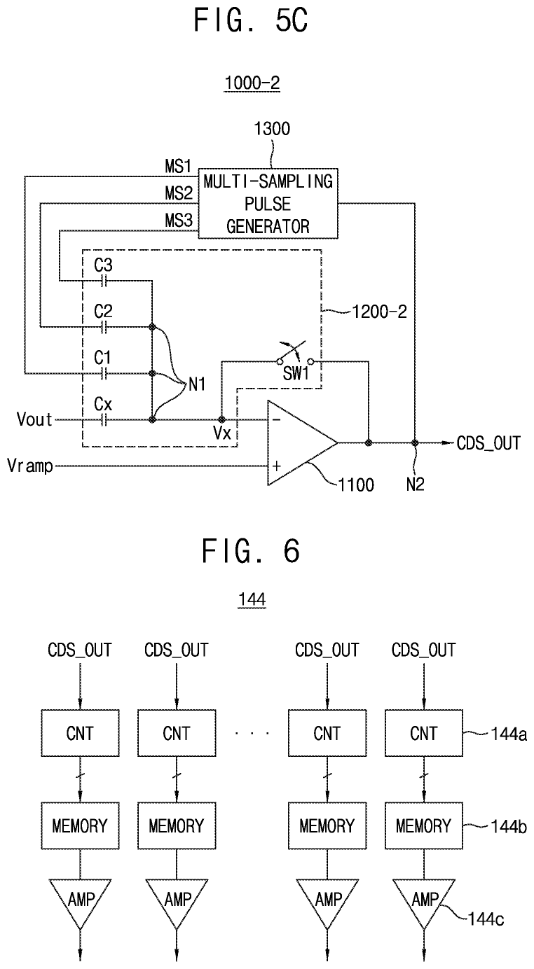

FIG. 5A is a view showing the CDS circuit 1000 of the CDS block 142 of FIG. 4 according to an exemplary embodiment of the inventive concept.

Referring to FIG. 5A, the CDS circuit 1000 may include a comparator 1100, a multi-sampling circuit 1200, and a multi-sampling pulse generator 1300. Herein, the terms “comparator” and “comparator circuit” may be used interchangeably, and the terms “multi-sampling pulse generator” and “multi-sampling pulse generator circuit” may be used interchangeably. Each of the CDS circuits 1000 may perform CDS on pixel signals Vout (reset signals and image signals) output from each of the column lines.

The comparator 1100 may include a first input terminal (a negative (−) input terminal) to which the pixel signal Vout (the reset signal and the image signal) is input from the unit pixel 112, a second input terminal (a positive (+) input terminal) to which the ramp signals Vramp are input from the ramp signal generator 150, and an output terminal.

The comparator 1100 may compare a voltage of the pixel signal Vout sampled by CDS, that is, a voltage Vx of a first node N1, with a voltage (e.g., a voltage level) of the ramp signal Vramp. Here, in a reset sampling period, a reset signal reset may be input to the first input terminal of the comparator 1100 and a first ramp signal Vramp1 may be input to the second input terminal. In a signal sampling period, an image signal Vpix may be input to the first input terminal of the comparator 1100 and a second ramp signal Vramp2 may be input to the second input terminal.

The comparator 1100 may generate a CDS output signal CDS_OUT according to a comparison result of the voltage of the pixel signal Vout (the reset signal and the image signal) sampled by the CDS and the voltages of the ramp signals Vramp. The comparator 1100 may output the generated CDS output signal CDS_OUT to the ADC144. In this case, the CDS output signal CDS_OUT output from the comparator 1100 may correspond to a value of a difference between the image signal Vpix and the reset signal reset. The ramp signals Vramp may be used to output the difference between the image signal Vpix and the reset signal reset. The difference between the image signal Vpix and the reset signal reset may be determined and output according to a slope of the ramp signal Vramp.

The multi-sampling circuit 1200 may include a correction capacitor Cx, a plurality of sampling capacitors C1 and C2, and a first switch SW1. The correction capacitor Cx may also be referred to herein as a stabilization capacitor.

The first switch SW1 may connect the first node N1, which is connected to the first input terminal of the comparator 1100, to a second node N2 (output node) in response to an auto-zero control signal which is input from the timing generator 130 in the reset sampling period. When the first switch SW1 is turned on, a voltage value of the first node N1 may be reset to be a voltage value of an output terminal, which may remove reset noise and an offset of the comparator 1100.

The correction capacitor Cx may be disposed between an input terminal of the CDS circuit 1000 to which the pixel signal Vout is input and the first input terminal (the negative (−) input terminal) of the comparator 1100. The first input terminal of the comparator 1100 is connected to the first node N1.

The correction capacitor Cx may be disposed between the input terminal of the CDS circuit 1000 and the first node N1. The correction capacitor Cx blocks a direct current (DC) voltage that can be output and included in the pixel signal Vout so that a corrected voltage value is output.

A first terminal of a first sampling capacitor C1 may be connected to a first output terminal of the multi-sampling pulse generator 1300, and a second terminal of the first sampling capacitor C1 may be connected to the first node N1. A first multi-sampling pulse MS1 output from the multi-sampling pulse generator 1300 may be applied to the first sampling capacitor C1.

A first terminal of a second sampling capacitor C2 may be connected to a second output terminal of the multi-sampling pulse generator 1300, and a second terminal of the second sampling capacitor C2 may be connected to the first node N1. A second multi-sampling pulse MS2 output from the multi-sampling pulse generator 1300 may be applied to the second sampling capacitor C2.

The first sampling capacitor C1 and the second sampling capacitor C2 may also be referred to herein as multi-sampling capacitors.

An input terminal of the multi-sampling pulse generator 1300 may be connected to the second node N2.

The multi-sampling pulse generator 1300 may generate and output the first multi-sampling pulse MS1 and the second multi-sampling pulse MS2 on the basis of the CDS output signal CDS_OUT of the comparator 1100.

For example, in the reset sampling period, the multi-sampling pulse generator 1300 may receive the CDS output signal CDS_OUT of the comparator 1100 and, after a first time has elapsed, output the first multi-sampling pulse MS1 to the first sampling capacitor C1. In addition, in the reset sampling period, the multi-sampling pulse generator 1300 may receive the CDS output signal CDS_OUT of the comparator 1100 and, after a second time has elapsed, output the second multi-sampling pulse MS2 to the second sampling capacitor C2. In this case, the multi-sampling pulse generator 1300 may output the first multi-sampling pulse MS1 and then output the second multi-sampling pulse MS2. That is, the second multi-sampling pulse MS2 may be output subsequent to the output of the first multi-sampling pulse MS1.

For example, in the signal sampling period, the multi-sampling pulse generator 1300 may receive the CDS output signal CDS_OUT of the comparator 1100 and, after the first time has elapsed, output the first multi-sampling pulse MS1 to the first sampling capacitor C1. In addition, in the signal sampling period, the multi-sampling pulse generator 1300 may receive the CDS output signal CDS_OUT of the comparator 1100 and, after the second time has elapsed, output the second multi-sampling pulse MS2 to the second sampling capacitor C2. In this case, the multi-sampling pulse generator 1300 may output the first multi-sampling pulse MS1 and then output the second multi-sampling pulse MS2. That is, the second multi-sampling pulse MS2 may be output subsequent to the output of the first multi-sampling pulse MS1.

As described above, the CDS circuit 1000 shown in FIG. 5A may perform sampling on the reset signal reset three times in the reset sampling period, and may perform sampling on the image signal Vpix three times in the signal sampling period, using the correction capacitor Cx, the first sampling capacitor C1, and the second sampling capacitor C2 which are connected to the first node N1. However, the inventive concept is not limited thereto. For example, according to exemplary embodiments, the number of times of multi-sampling may be adjusted according to the number of sampling capacitors connected to the first node N1.

FIG. 5B is a view showing a CDS circuit 1000-1 of the CDS block 142 of FIG. 4 according to an exemplary embodiment of the inventive concept.

Referring to FIG. 5B, in a multi-sampling circuit 1200-1, a correction capacitor Cx and a first sampling capacitor C1 may be connected to a first node N1 of the CDS circuit 1000-1. In comparison to the CDS circuit 1000 of FIG. 5A, the second sampling capacitor C2 is omitted. For convenience of explanation, a further description of elements and technical aspects previously described may be omitted herein.

In a reset sampling period, a multi-sampling pulse generator 1300 may receive a CDS output signal CDS_OUT of a comparator 1100 and, after a first time has elapsed, output a first multi-sampling pulse MS1 to the first sampling capacitor C1. That is, the first multi-sampling pulse MS1 may be applied to the first sampling capacitor C1.

For example, in a signal sampling period, the multi-sampling pulse generator 1300 may receive the CDS output signal CDS_OUT of the comparator 1100 and, after the first time has elapsed, output the first multi-sampling pulse MS1 to the first sampling capacitor C1. That is, the first multi-sampling pulse MS1 may be applied to the first sampling capacitor C1.

The CDS circuit 1000-1 shown in FIG. 5B may perform sampling on a reset signal reset two times in the reset sampling period, and may perform sampling on an image signal Vpix two times in the signal sampling period, using the correction capacitor Cx and the first sampling capacitor C1 which are connected to the first node N1.

FIG. 5C is a view showing a CDS circuit 1000-2 of the CDS block 142 of FIG. 4 according to an exemplary embodiment of the inventive concept.

Referring to FIG. 5C, in a multi-sampling circuit 1200-2, a correction capacitor Cx, a first sampling capacitor C1, a second sampling capacitor C2, and a third sampling capacitor C3 may be connected to a first node N1 of the CDS circuit 1000-2. In comparison to the CDS circuit 1000 of FIG. 5A, an additional third sampling capacitor C3 is further included, and a third multi-sampling pulse MS3 may be output from the multi-sampling pulse generator 1300 and applied to the third sampling capacitor C3. The third sampling capacitor C3 may also be referred to herein as a multi-sampling capacitor. For convenience of explanation, a further description of elements and technical aspects previously described may be omitted herein.

For example, the CDS circuit 1000-2 according to the exemplary embodiment may include at least three sampling capacitors C1, C2, and C3. Therefore, the CDS circuit 1000-2 may perform sampling on a reset signal reset multiple times in a reset sampling period. In addition, the CDS circuit 1000-2 may perform sampling on an image signal Vpix multiple times in a signal sampling period.

As shown in FIGS. 5A to 5C, the numbers of times of reset sampling and signal sampling may be adjusted according to the number of sampling capacitors connected to the first node N1. When a sampling capacitor is additionally disposed, the numbers of times of reset sampling and signal sampling may be further increased.

FIG. 6 is a view showing the ADC144 of the read-out circuit 140 of FIG. 2 according to an exemplary embodiment of the inventive concept.

Referring to FIG. 6, the ADC144 may receive the CDS output signal CDS_OUT from the CDS block 142 in response to the clock signal CLK received from the timing generator 130. The ADC144 may convert an analog image signal into a digital image signal and output the generated digital image signal.

The buffer circuit 146 may latch and amplify the digital image signal output from the ADC144 to transmit the amplified digital image signal to the DSP 200.

The ADC 144 may include a plurality of counters (CNTs) 144a, a plurality of memories 144b, and a plurality of amplifiers (AMPs) 144c. Each of the plurality of CNTs 144a may be connected to the second node N2 of the CDS circuit 1000. Each of the plurality of CNTs 144a may output a result of counting up to a point, at which the reset signal reset and the first ramp signal Vramp1 become equal to each other, as a digital signal. In addition, each of the plurality of CNTs 144a may output a result of counting up to a point, at which the image signal Vpix and the second ramp signal Vramp2 become equal to each other, as a digital signal. The plurality of CNTs 144a may include an up/down counter and a bit-wise inversion counter.

The plurality of memories 144b may operate based on the control signals which are input from the timing generator 130. The plurality of memories 144b may temporarily store the digital signals of the plurality of CNTs 144a and then may output the digital signals to the plurality of AMPs 144c. The plurality of memories 144b may each include, for example, a static random access memory (SRAM). However, the memories 144b are not limited thereto. The plurality of AMPs 144c may amplify the input digital signals and then transmit the amplified digital signals to the DSP 200.

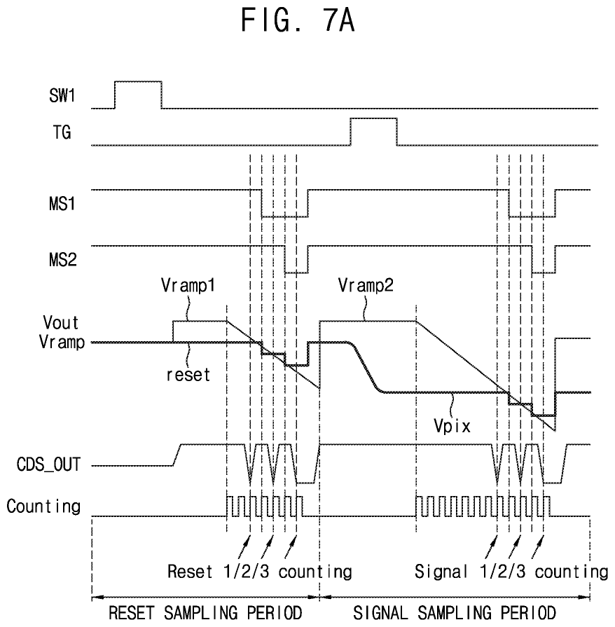

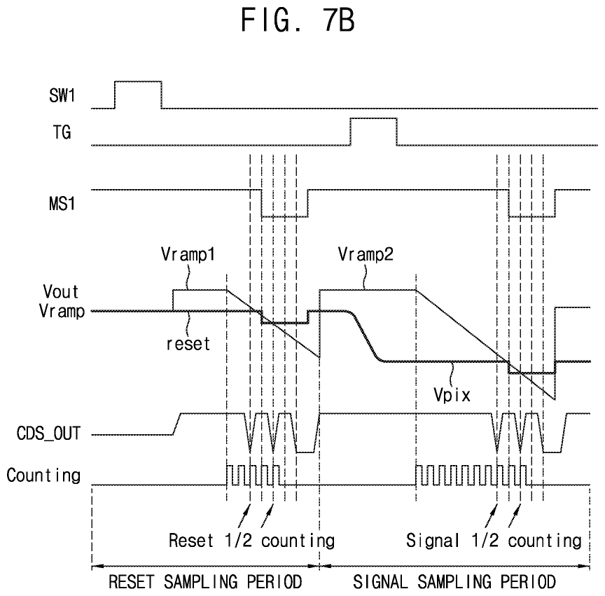

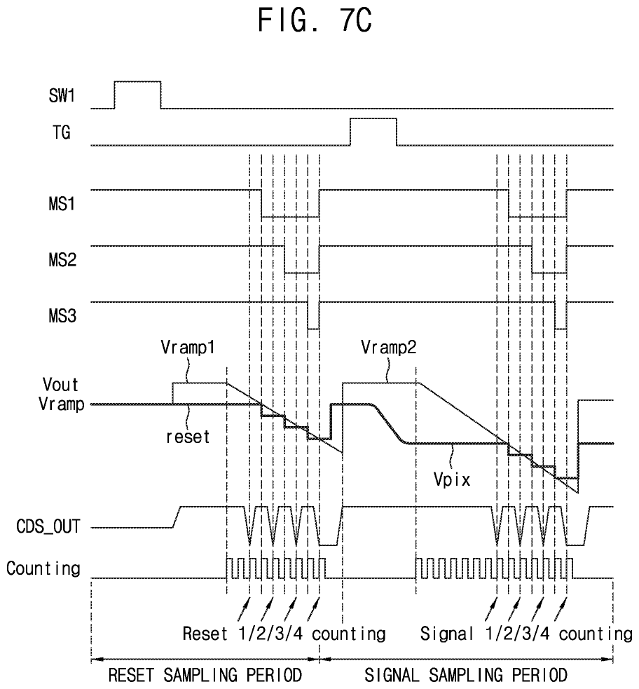

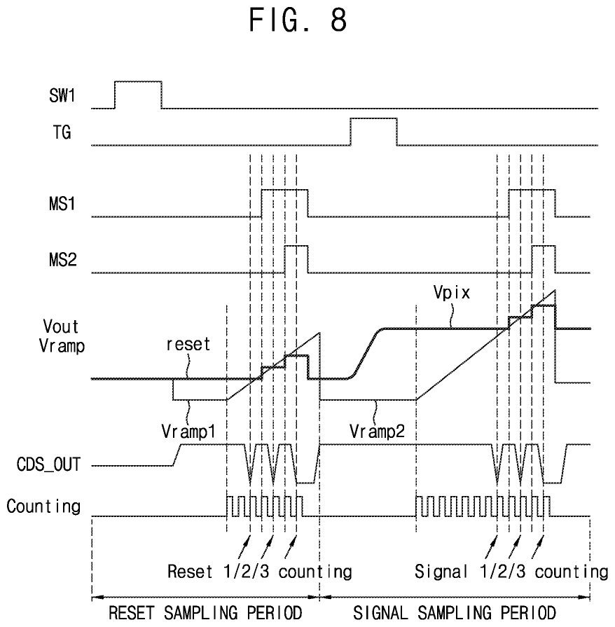

FIG. 7A is a timing diagram of signals for driving the image sensor 100 of FIG. 1 according to an exemplary embodiment of the inventive concept. Hereinafter, an example of a method of driving an image sensor 100 including the CDS circuit 1000 in which two sampling capacitors are disposed, as shown in FIG. 5A, will be described.

Referring to FIGS. 5A and 7A, pixel signals Vout output from the unit pixel may include a reset signal reset and an image signal Vpix. The reset signal reset may be input to the CDS circuit 1000 in a reset sampling period, and the image signal Vpix may be input to the CDS circuit 1000 in a signal sampling period.

The CDS circuit 1000 may output a difference between the reset signal reset, which is output in the reset sampling period ,and the image signal Vpix, which is output in the signal sampling period. To this end, the CDS circuit 1000 may determine the difference between the reset signal reset and the image signal Vpix using the first ramp signal Vramp1 and the second ramp signal Vramp2. In addition, the CDS circuit 1000 may output a comparison signal according to slopes of the first ramp signal Vramp1 and the second ramp signal Vramp2.

The method of driving the image sensor 100 in the reset sampling period according to an exemplary embodiment will be described.

In the reset sampling period for sampling a reset signal reset, the reset signal reset may be input from the unit pixel 112 to the CDS circuit 1000. At substantially the same time, the first ramp signal Vramp1 may be input from the ramp signal generator 150 to the CDS circuit 1000. In this case, the reset signal reset may be input to the first input terminal of the comparator 1100, and the first ramp signal Vramp1 may be input to the second input terminal.

A reset signal reset having a first voltage value at the beginning of the reset sampling period may be input to the first input terminal of the comparator 1100.

After a preset first time has elapsed, a first multi-sampling pulse MS1 may be applied to the first sampling capacitor C1 from the multi-sampling pulse generator 1300. When the first multi-sampling pulse MS1 is applied to the first sampling capacitor C1 from the multi-sampling pulse generator 1300, a value of the voltage Vx of the first node N1 connected to the first input terminal (the negative (−) input terminal) of the comparator 1100 may be lowered to be a second voltage value lower than the first voltage value. In this case, since the first ramp signal Vramp1 is generated so as to fall from a high voltage to a low voltage with the passage of time, a voltage value of the reset signal reset may be gradually lowered from the first voltage value to the second voltage value for multi-sampling.

Next, a second multi-sampling pulse MS2 may be applied to the second sampling capacitor C2 from the multi-sampling pulse generator 1300 in a state in which the first multi-sampling pulse MS1 is applied to the first sampling capacitor C1. When the second multi-sampling pulse MS2 is applied to the second sampling capacitor C2 from the multi-sampling pulse generator 1300, the value of the voltage Vx of the first node N1 connected to the first input terminal (the negative (−) input terminal) of the comparator 1100 may be lowered to be a third voltage value lower than the second voltage value. In this case, since the first ramp signal Vramp1 is generated so as to fall from a high voltage to a low voltage with the passage of time, the voltage value of the reset signal reset may be gradually lowered from the second voltage value to the third voltage value for multi-sampling.

In the reset sampling period, the first multi-sampling pulse MS1 may be applied to the first sampling capacitor C1 for a duration corresponding to the first time. The second multi-sampling pulse MS2 may be applied to the second sampling capacitor C2 for a second time having a duration shorter than that of the first time. The multi-sampling pulse generator 1300 may maintain an output of the first multi-sampling pulse MS1 until an output of the second multi-sampling pulse MS2 is completed. In the reset sampling period, start points of the outputs of the first multi-sampling pulse MS1 and the second multi-sampling pulse MS2 are different, but end points thereof may be the same.

As described above, in the reset sampling period, the voltage value of the reset signal reset input to the first input terminal of the comparator 1100 may be gradually lowered from the first voltage value to the second voltage value and the third voltage value, and the voltage values may be sequentially compared with the first ramp signal Vramp1. Multi-sampling may be performed on reset signals reset by outputting comparison results of the first ramp signal Vramp1 with the first voltage value, the second voltage value, and the third voltage value as CDS output signals CDS_OUT. Each of the plurality of CNTs 144a of the ADC144 may count the clock signals up to a plurality of points at which the first ramp signal Vramp1 and the reset signal reset become the same on the basis of the CDS output signals CDS_OUT input from the CDS circuit 1000.

The method of driving the image sensor 100 in the signal sampling period according to an exemplary embodiment will now be described.

In the signal sampling period for sampling an image signal Vpix, the image signal Vpix may be input from the unit pixel 112 to the CDS circuit 1000. At substantially the same time, the second ramp signal Vramp2 may be input from the ramp signal generator 150 to the CDS circuit 1000. In this case, the reset signal reset may be input to the first input terminal of the comparator 1100, and the second ramp signal Vramp2 may be input to the second input terminal.

An image signal Vpix having a first voltage value at the beginning of the signal sampling period may be input to the first input terminal of the comparator 1100.

After a preset first time has elapsed, a first multi-sampling pulse MS1 may be applied to the first sampling capacitor C1 from the multi-sampling pulse generator 1300. When the first multi-sampling pulse MS1 is applied to the first sampling capacitor C1 from the multi-sampling pulse generator 1300, a value of the voltage Vx of the first node N1 connected to the first input terminal (the negative (−) input terminal) of the comparator 1100 may be lowered to be a second voltage value lower than the first voltage value. In this case, since the second ramp signal Vramp2 is generated so as to fall from a high voltage to a low voltage with the passage of time, a voltage value of the image signal Vpix may be gradually lowered from the first voltage value to the second voltage value for multi-sampling.

Next, a second multi-sampling pulse MS2 may be applied to the second sampling capacitor C2 from the multi-sampling pulse generator 1300 in a state in which the first multi-sampling pulse MS1 is applied to the first sampling capacitor C1. When the second multi-sampling pulse MS2 is applied to the second sampling capacitor C2 from the multi-sampling pulse generator 1300, the value of the voltage Vx of the first node N1 connected to the first input terminal (the negative (−) input terminal) of the comparator 1100 may be lowered to be a third voltage value lower than the second voltage value. In this case, since the second ramp signal Vramp2 is generated so as to fall from a high voltage to a low voltage with the passage of time, the voltage value of the image signal Vpix may be gradually lowered from the second voltage value to the third voltage value for multi-sampling.

In the signal sampling period, the first multi-sampling pulse MS1 may be applied to the first sampling capacitor C1 for a duration corresponding to the first time. The second multi-sampling pulse MS2 may be applied to the second sampling capacitor C2 for a second time having a duration shorter than that of the first time. The multi-sampling pulse generator 1300 may maintain an output of the first multi-sampling pulse MS1 until an output of the second multi-sampling pulse MS2 is completed. In the signal sampling period, start points of the outputs of the first multi-sampling pulse MS1 and the second multi-sampling pulse MS2 are different, but end points thereof may be the same.

As described above, in the signal sampling period, the voltage value of the image signal Vpix input to the first input terminal of the comparator 1100 may be gradually lowered from the first voltage value to the second voltage value and the third voltage value, and the voltage values may be sequentially compared with the second ramp signal Vramp2. Multi-sampling may be performed on image signals Vpix by outputting comparison results of the second ramp signal Vramp2 with the first voltage value, the second voltage value, and the third voltage value as CDS output signals CDS_OUT. Each of the plurality of CNTs 144a of the ADC144 may count the clock signals up to a plurality of points at which the second ramp signal Vramp2 and the image signal Vpix become the same.

FIG. 7B is a timing diagram of signals for driving the image sensor 100 of FIG. 1 according to an exemplary embodiment of the inventive concept. Hereinafter, an example of a method of driving an image sensor 100 including the CDS circuit 1000-1 in which one sampling capacitor is disposed, as shown in FIG. 5B, will be described.

Referring to FIGS. 5B and 7B, in the reset sampling period, a voltage value of the reset signal reset input to the first input terminal of the comparator 1100 may be gradually lowered from a first voltage value to a second voltage value, and the voltage values may be sequentially compared with the first ramp signal Vramp1. Multi-sampling may be performed on reset signals reset by outputting comparison results of the first ramp signal Vramp1 with the first voltage value and the second voltage value as CDS output signals CDS_OUT.

In the signal sampling period, a voltage value of the image signal Vpix input to the first input terminal of the comparator 1100 may be gradually lowered from a first voltage value to a second voltage value, and the voltage values may be sequentially compared with the second ramp signal Vramp2. Multi-sampling may be performed on image signals Vpix by outputting a comparison result of the second ramp signal Vramp2 with the first voltage value and the second voltage value as a CDS output signal CDS_OUT.

FIG. 7C is a timing diagram of signals for driving the image sensor 100 of FIG. 1 according to an exemplary embodiment of the inventive concept. Hereinafter, an example of a method of driving an image sensor 100 including the CDS circuit 1000-2 in which three sampling capacitors are disposed, as shown in FIG. 5C, will be described.

Referring to FIGS. 5C and 7C, in the reset sampling period, a voltage value of the reset signal reset input to the first input terminal of the comparator 1100 may be gradually lowered from a first voltage value to a second voltage value, a third voltage value, and a fourth voltage value, and the voltage values may be sequentially compared with the first ramp signal Vramp1. Multi-sampling may be performed on reset signals reset by outputting a comparison result of the first ramp signal Vramp1 with the first voltage value, the second voltage value, the third voltage value, and the fourth voltage value as a CDS output signal CDS_OUT.

In the signal sampling period, a voltage value of the image signal Vpix input to the first input terminal of the comparator 1100 may be gradually lowered from a first voltage value to a second voltage value, a third voltage value, and a fourth voltage value, and the voltage values may be sequentially compared with the second ramp signal Vramp2. Multi-sampling may be performed on image signals Vpix by outputting a comparison result of the second ramp signal Vramp2 with the first voltage value, the second voltage value, the third voltage value, and the fourth voltage value as a CDS output signal CDS_OUT.

FIG. 8 is a timing diagram of signals for driving the image sensor 100 of FIG. 1 according to an exemplary embodiment of the inventive concept.

Referring to FIGS. 5A and 8, in the reset sampling period, the first ramp signal Vramp1 that rises from a low voltage to a high voltage with the passage of time may be input to the CDS circuit 1000. In this case, the multi-sampling pulse generator 1300 may generate a first multi-sampling pulse MS1 for raising a voltage value of the reset signal reset from a first value to a second value, and may apply the generated first multi-sampling pulse MS1 to the first sampling capacitor C1. When the first multi-sampling pulse MS1 is applied to the first sampling capacitor C1, the voltage value of the reset signal reset may be raised to be a second voltage value higher than a first voltage value.

In a state in which the first multi-sampling pulse MS1 is applied to the first sampling capacitor C1, the multi-sampling pulse generator 1300 may generate a second multi-sampling pulse MS2 for raising the voltage value of the reset signal reset from the second value to a third value, and may apply the generated second multi-sampling pulse MS2 to the second sampling capacitor C2. When the second multi-sampling pulse MS2 is applied to the second sampling capacitor C2, the voltage value of the reset signal reset may be raised to be a third voltage value higher than the second voltage value.

As described above, in the reset sampling period, the voltage value of the reset signal reset input to the first input terminal of the comparator 1100 may be gradually raised from the first voltage value to the second voltage value and the third voltage value so that multi-sampling may be performed on image signals Vpix.

In the signal sampling period, the second ramp signal Vramp2 that rises from a low voltage to a high voltage with the passage of time may be input to the CDS circuit 1000. In this case, the multi-sampling pulse generator 1300 may generate a first multi-sampling pulse MS1 for raising a voltage value of the image signal Vpix from a first value to a second value, and may apply the generated first multi-sampling pulse MS1 to the first sampling capacitor C1. When the first multi-sampling pulse MS1 is applied to the first sampling capacitor C1, the voltage value of the image signal Vpix may be gradually raised to be a second voltage value higher than a first voltage value.

In a state in which the first multi-sampling pulse MS1 is applied to the first sampling capacitor C1, the multi-sampling pulse generator 1300 may generate a second multi-sampling pulse MS2 for raising the voltage value of the image signal Vpix from the second value to a third value, and may apply the generated second multi-sampling pulse MS2 to the second sampling capacitor C2. When the second multi-sampling pulse MS2 is applied to the second sampling capacitor C2, the voltage value of the image signal Vpix may be gradually raised to be a third voltage value higher than the second voltage value.

As described above, in the signal sampling period, the voltage value of the reset signal reset input to the first input terminal of the comparator 1100 may be gradually raised from the first voltage value to the second voltage value and the third voltage value so that the multi-sampling may be performed on image signals Vpix.

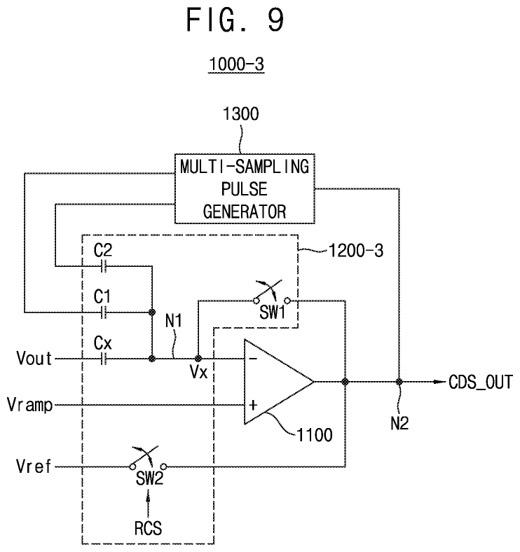

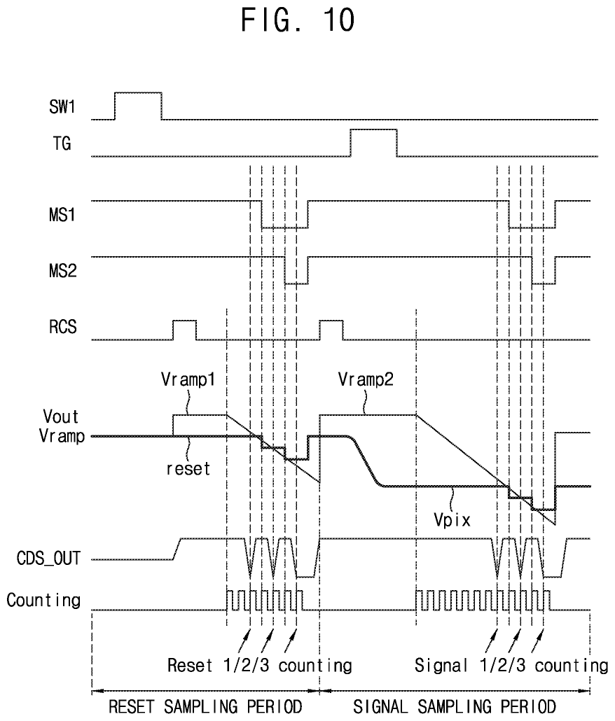

FIG. 9 is a view showing a CDS circuit 1000-3 of the CDS block 142 of FIG. 4 according to an exemplary embodiment of the inventive concept.

Referring to FIG. 9, the CDS circuit 1000-3 may include a comparator 1100, a multi-sampling circuit 1200-3, and a multi-sampling pulse generator 1300. For convenience of explanation, a further description of elements and technical aspects previously described may be omitted herein.

The multi-sampling circuit 1200-3 may include a correction capacitor Cx, a plurality of sampling capacitors C1 and C2, a first switch SW1, and a second switch SW2.

The first switch SW1 may connect a first node N1 of the comparator 1100 to a second node N2 in response to an auto-zero control signal, which is input from the timing generator 130, in the reset sampling period. When the first switch SW1 is turned on, a voltage value of the first node N1 may be reset to be a voltage value of an output terminal to remove reset noise and an offset of the comparator 1100.

A first terminal of the second switch SW2 may be connected to a reference voltage Vref terminal, and a second terminal may be connected to an output terminal of the comparator 1100. The second switch SW2 may reset a voltage value of the second node N2 connected to the output terminal of the comparator 1100 in response to a reset control signal RCS input from the timing generator 130 in the reset sampling period and the signal sampling period. A stabilization time of an output signal of the comparator 1100 may vary according to a time at which the ramp signal Vramp reaches an offset level, and a total sampling time increases due to the wait until the output signal of the comparator 1100 is stabilized.

In the CDS circuit 1000-3, the second switch SW2 may be disposed between the output terminal of the comparator 1100 and the reference voltage Vref terminal, and the second switch SW2 may be turned on in the reset sampling period and the signal sampling period. When the second switch SW2 is turned on, the reference voltage Vref may be supplied to the second node N2 so that the stabilization time of the output signal of the comparator 1100 may be reduced. That is, an output voltage of the comparator 1100 may be set to a level of the reference voltage Vref and the subsequent operation may start immediately, thereby reducing the total sampling time. Here, the reference voltage Vref may have a level of a power voltage VDD, a level of a ground voltage GND, or a level of a preset voltage between the power voltage VDD and the ground voltage GND.

FIG. 10 is a timing diagram of signals for driving the image sensor 100 of FIG. 1 according to an exemplary embodiment of the inventive concept. Hereinafter, an example of a method of driving an image sensor 100 including the CDS circuit 1000-3, as shown in FIG. 9, will be described.

Referring to FIG. 10, in the reset sampling period, the reset signal reset may be input to the CDS circuit 1000 from the unit pixel 112, and the first ramp signal Vramp1 may be input to the CDS circuit 1000 from the ramp signal generator 150. In this case, the reset signal reset may be input to the first input terminal of the comparator 1100, and the first ramp signal Vramp1 may be input to the second input terminal. At substantially the same time, a reset control signal may be applied to the second switch SW2, and the second switch SW2 may be turned on in response to the reset control signal. A reference voltage Vref may be supplied to the second node N2 through the second switch SW2 so that a voltage of the second node N2 may be reset to be the level of the reference voltage Vref.

In the reset sampling period, the CDS circuit 1000-3 may gradually lower the voltage value of the reset signal reset input to the first input terminal of the comparator 1100 from a first voltage value to a second voltage value and a third voltage value, so that multi-sampling may be performed on reset signals reset.

Next, in the signal sampling period, the image signal Vpix may be input to the CDS circuit 1000-3 from the unit pixel 112, and the first ramp signal Vramp1 may be input to the CDS circuit 1000-3 from the ramp signal generator 150. In this case, the image signal Vpix may be input to the first input terminal of the comparator 1100, and the second ramp signal Vramp2 may be input to the second input terminal. At substantially the same time, the reset control signal may be applied to the second switch SW2, and the second switch SW2 may be turned on in response to the reset control signal. The reference voltage Vref may be supplied to the second node N2 through the second switch SW2 so that the voltage of the second node N2 may be reset to be the level of the reference voltage Vref.

As described above, in the signal sampling period, the CDS circuit 1000-3 may gradually lower the voltage value of the image signal Vpix input to the first input terminal of the comparator 1100 from a first voltage value to a second voltage value and a third voltage value, so that multi-sampling may be performed on the image signals Vpix.

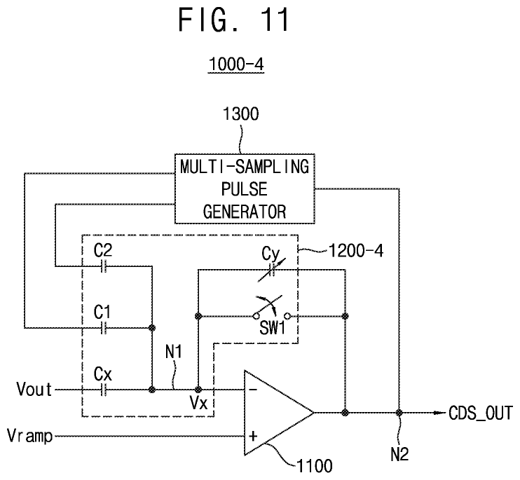

FIG. 11 is a view showing a CDS circuit 1000-4 of the CDS block 142 of FIG. 4 according to an exemplary embodiment of the inventive concept.

Referring to FIGS. 7A and 11, the CDS circuit 1000-4 may include a comparator 1100, a multi-sampling circuit 1200-4, and a multi-sampling pulse generator 1300. For convenience of explanation, a further description of elements and technical aspects previously described may be omitted herein.

The multi-sampling circuit 1200-4 may include a correction capacitor Cx, a plurality of sampling capacitors C1 and C2, a coupling capacitor Cy, and a first switch SW1. A first terminal of the coupling capacitor Cy may be connected to the first input terminal of the comparator 1100, and a second terminal may be connected to the output terminal of the comparator 1100.

The CDS circuit 1000-4 may adjust a ratio of a first capacitance which is a sum of all capacitances of the correction capacitor Cx to a third capacitor to a second capacitance of the coupling capacitor Cy to amplify an output signal in the reset sampling period and the signal sampling period. To this end, a variable capacitor capable of adjusting the capacitance may be utilized as the coupling capacitor Cy. However, the inventive concept is not limited thereto. For example, according to exemplary embodiments, one or more first to third capacitors C1 to C3 may be implemented as a capacitor having a variable capacitance, and the coupling capacitor Cy may be implemented as a capacitor having a fixed capacitance.

For example, a ratio of the first capacitance to the second capacitance of the CDS circuit 1000-4 may be set to M:1 (M is a natural number). Accordingly, the CDS circuit 1000-4 may output a signal amplified by 1/M times. For example, the ratio of the first capacitance to the second capacitance of the CDS circuit 1000-4 may be set to 1:M. Accordingly, the CDS circuit 1000-4 may output a signal amplified by M times or output a signal amplified by 1/M times. However, the inventive concept is not limited thereto. For example, according to exemplary embodiments, the ratio of 1:1 may be set so that the first capacitance and the second capacitance of the CDS circuit 1000-4 are about equal to each other.

In the reset sampling period, the CDS circuit 1000-4 may gradually lower a voltage value of the reset signal reset input to the first input terminal of the comparator 1100 from a first voltage value to a second voltage value and a third voltage value so that multi-sampling may be performed on reset signals reset.

In the signal sampling period, the CDS circuit 1000-4 may gradually lower a voltage value of the image signal Vpix input to the first input terminal of the comparator 1100 from a first voltage value to a second voltage value and a third voltage value so that multi-sampling may be performed on image signals Vpix.

According to exemplary embodiments of the inventive concept, a sampling time can be reduced when multi-sampling is performed using dual CDS.

As is traditional in the field of the inventive concept, exemplary embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the present inventive concept has been particularly shown and described with reference to the exemplary embodiments thereof, it should be understood by those skilled in the art that various changes in form and detail may be made therein without departing from the spirit and scope of the present inventive concept as defined by the following claims.

1. An image sensor, comprising:
a correlated double sampling (CDS) circuit, comprising:
a comparator having a first input terminal connected to a first node, a second input terminal, and an output terminal connected to a second node;
a multi-sampling pulse generator having an input terminal and at least one output terminal; and
a multi-sampling circuit,
wherein the multi-sampling circuit comprises:
a correction capacitor disposed between an input terminal of the CDS circuit and the first node; and
at least one sampling capacitor disposed between the at least one output terminal of the multi-sampling pulse generator and the first node.

2. The image sensor of claim 1, wherein:
the at least one output terminal of the multi-sampling pulse generator comprises a first output terminal and a second output terminal; and
the at least one sampling capacitor comprises:
a first sampling capacitor disposed between the first output terminal of the multi-sampling pulse generator and the first node; and
a second sampling capacitor disposed between the second output terminal of the multi-sampling pulse generator and the first node.

3. The image sensor of claim 2, wherein:
the at least one output terminal of the multi-sampling pulse generator further comprises a third output terminal; and
the at least one sampling capacitor further comprises a third sampling capacitor disposed between the third output terminal of the multi-sampling pulse generator and the first node.

4. The image sensor of claim 1, wherein the multi-sampling circuit further comprises:
a first switch disposed between the first node and the second node.

5. The image sensor of claim 1, wherein the input terminal of the multi-sampling pulse generator is connected to the second node.

6. The image sensor of claim 1, wherein the multi-sampling circuit further comprises:
a switch disposed between the second node and a reference voltage terminal.

7. The image sensor of claim I, wherein the multi-sampling circuit further comprises:
a coupling capacitor disposed between the first node and the second node.

8. An image sensor, comprising:
a correlated double sampling (CDS) circuit, comprising:
a comparator comprising a first input terminal to which a pixel signal is input, a second input terminal to which a ramp signal is input, and an output terminal,
wherein the first input terminal is connected to a first node, and the output terminal is connected to a second node;
a multi-sampling pulse generator comprising an input terminal connected to the output terminal of the comparator, and at least one output terminal connected to the first input terminal of the comparator; and
a multi-sampling circuit,
wherein the multi-sampling circuit comprises:
a correction capacitor disposed between an input terminal of the CDS circuit and the first input terminal of the comparator; and
at least one sampling capacitor disposed between the multi-sampling pulse generator and the first input terminal of the comparator.

9. The image sensor of claim 8, wherein:
the output terminal of the multi-sampling pulse generator comprises a first output terminal and a second output terminal; and
the at least one sampling capacitor comprises a first sampling capacitor and a second sampling capacitor,
wherein the first sampling capacitor is disposed between the first output terminal of the multi-sampling pulse generator and the first input terminal of the comparator; and
the second sampling capacitor is disposed between the second output terminal of the multi-sampling pulse generator and the first input terminal of the comparator.

10. The image sensor of claim 9, wherein the multi-sampling pulse generator outputs a first multi-sampling signal to the first sampling capacitor via the first output terminal of the multi-sampling pulse generator, and outputs a second multi-sampling signal to the second sampling capacitor via the second output terminal of the multi-sampling pulse generator, based on an output signal of the comparator output to the input terminal of the multi-sampling pulse generator.

11. The image sensor of claim 10, wherein a first multi-sampling pulse is input to the first sampling capacitor in a reset sampling period, and a voltage value of a reset signal which is input to the first node is changed from a first voltage value to a second voltage value.

12. The image sensor of claim 11, wherein a second multi-sampling pulse is input to the second sampling capacitor in a state in which the first multi-sampling pulse is applied to the first sampling capacitor, and the voltage value of the reset signal input to the first node is changed from the second voltage value to a third voltage value.

13. The image sensor of claim 12, wherein:
the ramp signal is applied to the second input terminal of the comparator in the reset sampling period;
the ramp signal has a constant falling slope in the reset sampling period; and
the CDS circuit gradually lowers the voltage value of the reset signal from the first voltage value to the second voltage value and then from the second voltage value to the third voltage value.

14. The image sensor of claim 13, wherein the comparator sequentially compares the ramp signal with the first to third voltage values of the reset signal and outputs a corresponding comparison result.

15. The image sensor of claim 12, wherein:
the ramp signal is applied to the second input terminal of the comparator in the reset sampling period;
the ramp signal has a constant rising slope in the reset sampling period; and
the CDS circuit gradually raises a voltage value of an image signal from the first voltage value to the second voltage value and then from the second voltage value to the third voltage value.

16. The image sensor of claim 15, wherein the comparator sequentially compares the ramp signal with the first to third voltage values of the reset signal and outputs a corresponding comparison result.

17. The image sensor of claim 11, wherein the first multi-sampling pulse is input to the first sampling capacitor in a signal sampling period, and a voltage value of an image signal which is input to the first node is changed from the first voltage value to the second voltage value.

18. The image sensor of claim 17, wherein a second multi-sampling pulse is input to the second sampling capacitor in a state in which the first multi-sampling pulse is applied to the first sampling capacitor, and the voltage value of the image signal which is input to the first node is changed from the second voltage value to a third voltage value.

19. The image sensor of claim 18, wherein:
the ramp signal is applied to the second input terminal of the comparator in the signal sampling period,
the ramp signal has a constant falling slope in the signal sampling period, and
the CDS circuit gradually lowers the voltage value of the image signal from the first voltage value to the second voltage value and then from the second voltage value to the third voltage value.

20. The image sensor of claim 19, wherein the comparator sequentially compares the ramp signal with the first to third voltage values of the image signal and outputs a corresponding comparison result.

21-31. (canceled)
